(19) United States
(12) Patent Application Publication
(10) Pub. No.: US 2025/0220375 A1
(43) Pub. Date: Jul. 3, 2025

(54) GENERATING SPATIALIZED AUDIO SIGNALS BASED ON MODAL INTERPOLATION OF IMPULSE RESPONSES

(71) Applicant: Mitsubishi Electric Research Laboratories, Inc., Cambridge, MA (US)

(72) Inventors: Gordon Wichern, Cambridge, MA (US); Yoshiki Masuyama, Tokyo (JP); François Germain, Cambridge, MA (US); Jonathan Le Roux, Cambridge, MA (US)

(73) Assignee: Mitsubishi Electric Research Laboratories, Inc., Cambridge, MA (US)

(21) Appl. No.: 18/403,195

(22) Filed: Jan. 3, 2024

(51) Int. Cl. H04S 7/00

(52) U.S. Cl. CPC H04S 7/30

(57) ABSTRACT

Systems, methods, software, and devices are disclosed herein that transform spatial input into modal output comprising learned modal components of an impulse response. A neural network interpolates the modal components of the impulse response based on a desired sound source direction represented in the spatial input. The learned modal components are then used to determine coefficients for an infinite impulse response filter that transforms anechoic audio into spatialized audio. The spatialized audio provides a directional effect to a listener as having arrived from the desired sound source direction.

### TECHNICAL FIELD

Aspects of the disclosure are related to the field of audio processing, and in particular, to spatialized audio technology.

### BACKGROUND

Spatialized audio refers to an audio effect that gives the impression to a listener that sound is arriving from a particular direction, when a headset, speaker, or other such sound source is proximate to the listener's ears. Users increasingly encounter spatialized audio in the context of virtual and augmented reality environments, multi-media applications, gaming experiences, and the like, where immersive experiences are popular and in demand.

Spatialized audio is created by configuring an impulse response (IR) filter to modify anechoic audio signals based on a head related transfer function (HRTF) and/or a room impulse response (RIR). The resulting spatialized audio signal output by the IR filter drives audio components that create the sound waves heard by a listener. The IR filter physically changes frequency and phase characteristics of the anechoic audio signal in accordance with the desired HRTF or RIR such that, when the sound waves arrive at a listener's ears, they create the impression that the sound originated from a desired sound source direction.

An immersive listening experience provided by spatialized audio requires HRTF samples of significant density that make them intractable at scale. Machine learning approaches have been proposed instead that estimate HRTFs at arbitrary directions. One such solution trains a neural network to estimate the magnitude response of an HRTF based on sound source direction. The interpolated magnitude response is converted to a time-domain finite impulse response (FIR) filter by the inverse discrete Fourier transform (DFT) with minimum phase. The FIR filter may then be applied to anechoic audio signals to produce spatialized audio signals associated with the desired sound source direction.

Unfortunately, it has proven difficult for neural networks to learn how to interpolate the magnitude response of an HRTF, resulting in spatialized audio of sub-optimal quality. In addition, implementations of FIR filters are computationally complex and utilize substantial amounts of memory, limiting their appeal and practicality.

### SUMMARY

Technology is disclosed herein that improves spatialized audio by way of a neural network that transforms spatial input into modal output comprising learned modal components of an impulse response. The neural network interpolates the modal components of the impulse response based on a desired sound source direction represented in the spatial input. The learned modal components are then used to determine coefficients for an infinite impulse response filter that transforms anechoic audio into spatialized audio. The spatialized audio provides a directional effect to a listener as having arrived from the desired sound source direction.

The neural network may be implemented in the context of computing hardware and software systems such as personal computers, server computers, mobile phones, gaming consoles, multi-media devices, and the like, which output spatialized audio via headphones, headsets, speakers, or other such peripherals. Other suitable contexts include the peripherals themselves such as headphones capable of executing the neural network. Indeed, the neural network may be employed to produce spatialized audio for a variety of applications such as virtual and/or augmented reality, gaming, and multi-media applications, to name just a few.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a spatialized audio system in an implementation.

FIG. 2 illustrates an audio processing method in an implementation.

FIGS. 3A-3B illustrate an operational example in an implementation.

FIG. 4 illustrates another operational example in an implementation.

FIG. 5 illustrates another operational example in an implementation.

FIGS. 6A and 6B illustrate training environments in an implementation.

FIG. 7 illustrates a sample data set and training data in an implementation.

FIG. 8 illustrates a training process in an implementation.

FIG. 9 illustrates multi-subject training process in an implementation.

FIG. 10 illustrates subject-specific training process in an implementation.

FIG. 11 illustrates an artificial neural network in an implementation.

FIG. 12 illustrates an output layer of a neural network in an implementation.

FIG. 13 illustrates data visualizations in an implementation.

FIG. 14 illustrates a computing system suitable for implementing the various operational environments, architectures, processes, scenarios, and sequences discussed below with respect to the other Figures.

### DETAILED DESCRIPTION

The acoustics from a sound environment can be represented by a linear signal referred to as an impulse response (IR), which is the sound received at each location in the environment for an impulse sound (similar to a “click”) generated from a specific source location. Two types of IRs in audio processing are room impulse responses (RIRs), which measure the IR between two points in an environment, and head-related transfer functions (HRTFs), which measure the IR from a location in free space to the ears of a listener, modeling the influence of the body, head, and ear shape of that listener. Both RIRs and HRTFs are advantageous for immersive audio in augmented/virtual reality among other applications, but difficult to collect in practice.

In general, the impulse response of a system, in the context of signal processing, is the system's output when it is subjected to an impulse input. In the time domain, it represents the behavior of the system over time. In the frequency domain, the impulse response is related to the system's transfer function. Because neural networks are mathematical models learned from data that are used to describe the spatiotemporal activity patterns of a physical quantity, it should not come as a surprise that recently neural networks have been used to provide the mapping from location coordinates to IRs. Existing methods focus on directly estimating the IRs either directly in the time domain as finite impulse response (FIR) filters or estimating the magnitude spectrum of the IR which is converted to an FIR filter.

FIR filters are a type of digital filter characterized by having a finite-duration response to an input signal. The term “finite impulse response” refers to the fact that the filter's output is determined by a finite number of past input samples, which are weighted and summed to produce the current output. However, FIR filters, whose coefficients can be calculated from neural network outputs, provide an expensive representation of the IR in terms of both computation and memory requirements. Indeed, under this approach, filters designed to transform anechoic audio signals into spatialized audio signals would have hundreds if not thousands of non-zero coefficients and must maintain large buffers of past samples requiring large memory usage.

Accordingly, audio processing systems, software, methods, and devices disclosed herein employ a neural network trained to spatially interpolate the modal components of an impulse response based on a sound source direction included in spatial input to the neural network. The learned modal components represent design parameters of an infinite impulse response (IIR) filter, which are converted into the coefficients of the IIR filter. IIR filters are characterized by having an impulse response that extends infinitely into the past. The name “infinite impulse response” reflects the fact that the filter's output is determined by a finite sum of past input samples and past output samples, which corresponds to an infinite sum of past input samples. IIR filters have a recursive structure, meaning that the output at a given time depends not only on the current input but also on previous output samples. This recursive nature often leads to more compact filter implementations compared to FIR filters. For example, whereas FIR filters have large quantities of non-zero coefficients, IIR filters require far fewer coefficients to approximate an IR, making IIR filters beneficial in terms of performance, memory usage, and computational load.

The resulting IIR filter configuration transforms anechoic audio signals into spatialized audio signals that provide an auditory directional effect to a listener of sound arriving from a desired sound source direction when, in reality, the sound is produced by a sound source proximate to the listener. Such technical effects result from the recognition of the modal nature of IRs, including RIRs and HRTFs, and that IRs can be approximated based on modal analysis. Modal analysis is a technique used to identify and study the modes of vibration of a system. Modes are the natural vibrational patterns that a system exhibits when excited. Modal analysis can be used in acoustics to understand the frequency dependent behavior of sound propagation. In the case of IRs, modes often appear as peaks and valleys of the transfer function, typically referred to as resonant peaks/valleys, which represent frequencies where geometry and material properties cause sound to accumulate/cancel. Hence, the embodiments disclosed herein are based on the understanding that the impulse response of a room or other space, such as the human head in the case of HRTFs, can be analyzed in terms of its modal components (i.e., resonant peaks/valleys).

To that end, a neural network may be trained with spatial coordinates specifying sound source and listener positions as input to output the parameters that characterize the resonant modes of an IR (e.g., an RIR or HRTF). Examples of such parameters include center frequency and bandwidth of different modes of vibration of the IR. Some embodiments are based on recognizing, testing, and proving that the spatiotemporal parameters of modal decomposition of the IR are sufficient to design stable IIR filters with fewer parameters than corresponding FIR filters. As a result, a combination of a neural network (trained accordingly) with an IIR filter results in a computationally and memory-efficient system for transforming an anechoic audio signal into a spatialized audio signal. For example, some embodiments are able to produce filters with just tens of coefficients instead of filters with many hundreds if not thousands of coefficients for FIR filters computed per existing techniques.

In addition, such neural networks may be trained on a per-subject basis, based on HRTFs measured specifically for individual users, and/or based on HRTFs that may be generally representative for a group of people, and thus satisfactory for the intended purpose. In other words, not only does the technology disclosed herein improve the practicality of spatialized audio in general, but it also increases the granularity with which spatialized audio may be provided to the listening population. Indeed, as will be appreciated from the discussion below, the ease with which a subject-specific neural network may be trained makes such an approach especially practical and desirable.

The neural networks contemplated herein may be trained based on spatial inputs to produce modal outputs. The spatial inputs include the sound source directions of multiple sound samples, while the modal outputs include the learned modal components of an impulse response. For example, HRTF measurements may be taken at a listener position with respect to multiple sound sources located at different positions relative to the listener position. As such, the sound source direction for each HRTF sample differs relative to the sound source direction of each other sample. The sound source direction may be represented in terms of the azimuth and elevation angles at which the measured sound arrives at the listener position. The spatial input may optionally include the distance from a sound source direction to a listener position, a subject identity associated with the listener, and other suitable inputs.

Training a neural network includes supplying a direction of a sound source as input to the neural network and obtaining output from the neural network that includes learned modal components of an estimated impulse response (e.g., an HRTF) for the direction of the sound source. Training further includes determining the coefficients for an IIR filter based on the learned modal components and then determining, based on the coefficients, an estimated frequency domain magnitude response of the estimated impulse response.

The training continues with performing a comparison of the estimated magnitude response to a known frequency domain magnitude response of the measured impulse response (e.g., the sampled HRTF for a specific person, or a representative HRTF for a specific person or group of people) and updating weights in the neural network based on the results of comparison. For example, the estimated magnitude response and the known magnitude response are supplied as inputs to a loss function that outputs a feedback signal to the neural network. Parameters of the neural network such as weights and biases are adjusted in accordance with known techniques until the training is complete.

During inference, the neural network receives spatial input and produces learned modal components as output. The learned modal components are converted to filter coefficients with which to configure an IIR filter. The IIR filter processes anechoic audio based on the coefficients to produce spatialized audio. The spatialized audio, when output as audible sound to a listener, produces an effect that the sound has arrived from elsewhere other than its actual origin. While the sound may be output by a headset, headphones, or speaker located at a position of the listener, the effect is that the sound arrived from a desired or virtual sound source direction removed from the listener's position in terms of its angle of arrival. For instance, the audio may sound like it originated to the left (or right) of the user, from behind (or in front of) the user, or from some other direction. The effect may also include a distance component such that the audio sounds like it originated near the user, distant from the user, or the like.

In some implementations, the spatialized audio may be tailored to the listener on a per-subject basis by incorporating the identity of subjects (listeners) during the training process, allowing a subject's identity or subject parameters to influence the neural network during inference. In one example, HRTF samples are collected on a per-subject basis for multiple subjects. While the sound source directions are encoded in feature vectors that are supplied to an input layer of the neural network, subject identities and/or subject parameters may be provided via a separate input channel. The subject identities and/or parameters may be used to control which parameters of the neural network are updated for a given subject. The neural network is able to learn from the training data to interpolate modal components based on subject identities and/or parameters.

The result of multi-subject training is in a sense, multiple neural networks (or parameter sets) corresponding to each subject. For instance, a base network may be trained on the HRTF for a first user. The base network may then be updated for a second, subsequent user based on the HRTF for that user, resulting in an updated version of the neural network, but without writing over or otherwise replacing the base network's parameters. At inference time, the base neural network would be loaded with respect to the first user to produce spatialized audio customized based on the HRFT for that user. Similarly, the second version of the neural network would be loaded with respect to the second user to produce spatialized audio customized based on the HRFT for that user.

In some cases, the base network may be trained on the HRTFs for a group of users. That is, rather than a single base user, a group will have multiple users, and multiple HRTFs corresponding to the multiple users. The network may be trained on the corresponding HRTF for each user in the group of base users. The base network may then be updated for a next user (after having been trained for the base users) based on the HRTF for the next user after the base group of users, resulting in an updated version of the neural network, but without writing over or otherwise replacing the base network's parameters. At inference time, the base neural network would be loaded with respect to any of the users in the base group to produce spatialized audio customized based on the HRFT for that user. Similarly, the updated version of the neural network would be loaded with respect to the next user to produce spatialized audio customized based on the HRFT for that user.

It may be appreciated that the technology disclosed herein to transform anechoic audio signals into spatialized audio signals applies as well to the transformation of audio signals having some existing spatialization into audio signals with an increased amount of spatialization. Indeed, the anechoic audio signals referred to throughout may inherently include some spatialized characteristics. That is, since an anechoic signal that is entirely free from any reflection or echo is difficult (if not impossible) to achieve in practice, the term “anechoic” is intended to refer to audio signals that—if not purely anechoic—are substantially less-spatialized than the spatialized audio signals produced in accordance with the disclosed implementations. Thus, the term “anechoic audio signal” as used throughout means both audio signals that are purely anechoic, as well as audio signals that are demonstrably anechoic relative to the spatialized audio signals that are produced in accordance with the disclosed implementations.

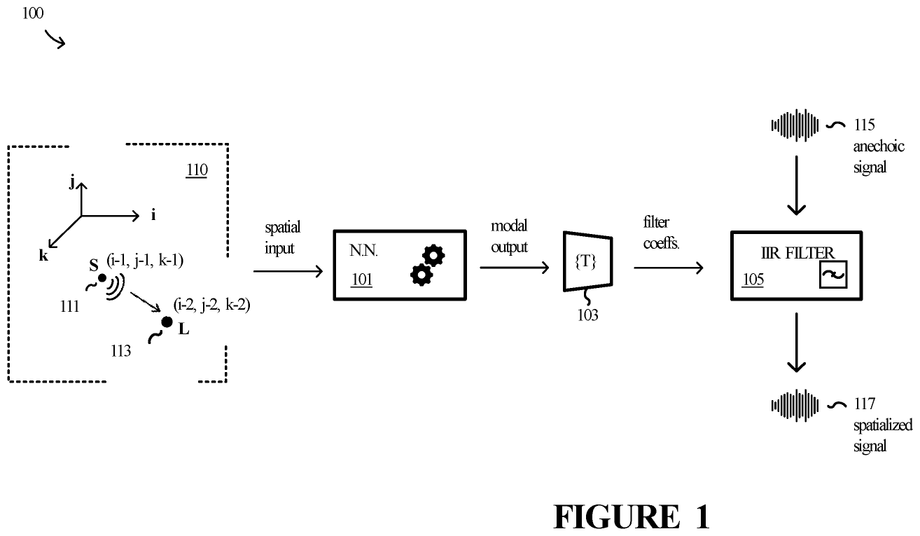

Turning to the figures, FIG. 1 illustrates spatialized audio system 100 in an implementation, referred to hereafter as system 100. System 100, which may be implemented in computer hardware, software, and/or firmware, includes neural network 101, conversion module 103, and IIR filter 105. Neural network 101 is operatively coupled with conversion module 103, while conversion module 103 is operatively coupled with IIR filter 105. Said coupling may include outputting certain values that are supplied as input to the next element. For example, neural network outputs learned model components to the input of conversion module 103, while conversion module 103 outputs filter coefficients with which to configure IIR filter 105.

Neural network 101 is representative of an artificial neural network or other such machine learning algorithm capable of processing spatial input and producing modal output. Conversion module 103 is representative of any functional block capable of transforming modal components to IR filter coefficient values. IIR filter 105 is representative of a cascaded audio filter capable of processing anechoic audio to produce spatialized audio based on the coefficients determined by conversion module 103. For example, IIR filter 105 may include a cascade of multiple IIR filter sections, where each IIR filter section corresponds to important perceptual characteristics in the frequency spectrum such as peaks, valleys, or roll-offs which are modeled by the modal components output by neural network 101. Neural network 101, conversion module 103, and IIR filter 105 may each be implemented in software or firmware executed by the circuitry of one or more processing devices on a single computing device or distributed across multiple computing devices. (Alternatively, or in addition, some or all of the functionality provided by any of neural network 101, conversion module 103, and IIR filter 105 may be implemented entirely via application-specific integrated circuits or other such special purpose processing devices.)

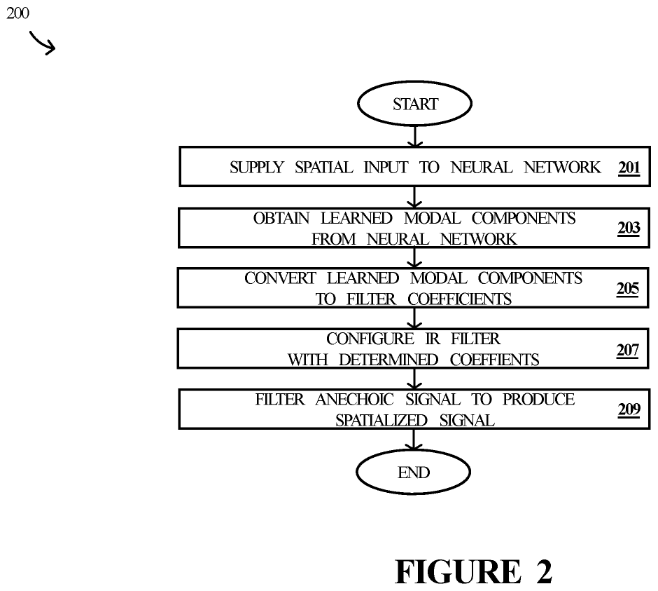

FIG. 2 illustrates an audio process 200 employed using system 100 to generate spatialized audio. Audio process 200 may be implemented in program instructions in the context of the software and/or firmware elements of system 100 such as neural network 101, conversion module 103, and IIR filter 105. The program instructions, when executed by one or more processing devices of one or more suitable computing devices, direct the one or more computing devices to operate as follows, referring parenthetically to the steps of FIG. 2 and in the singular to a computing device for the sake of clarity.

In operation, the computing device supplies spatial input to neural network 101 (step 201). The spatial input includes a desired sound source direction relative to a listener position. For example, the spatial input may indicate the direction in terms of a position of a sound source 111 relative to a listener position 113 in a virtual or augmented reality environment 110. The relative position may be indicated in terms of elevation and azimuth angles determined based on the two positions. The relative position may be supplied by an upstream application or component such as a virtual/augmented reality application, a multi-media application, a gaming application, or the like, capable of dynamically determining the direction as the relative position changes in real-time. In other cases, the direction may be a static value that is pre-determined and pre-programmed. The computing device supplies the spatial input in the form of a feature vector having the sound source direction encoded therein. Other information such as distance and/or a subject identity may also be encoded in the feature vector or otherwise supplied as input to the neural network. Alternatively, neural network 101 may be trained to encode the spatial input into a feature vector, in which case the spatial input may be input to the network in an encoded format.

Next, the computing device executes neural network 101 to obtain learned modal components based on the spatial input (step 203). As mentioned, neural network 101 may be an artificial neural network. In such implementations, neural network 101 includes an input layer, one or more hidden layers, and an output layer. The feature vector that represents the spatial input is fed to the input layer of the model. The feature vector may be produced using random Fourier feature (RFF) mapping or other suitable mechanisms.

The input layer includes n-number of input nodes that correspond to n-dimensions of the feature vector. Each of the input nodes processes a corresponding portion of the feature vector and pass their outputs to the hidden layers of the neural network. Each hidden layer takes the output of a previous layer as input and provides output to a subsequent layer of the neural network. The output layer of the neural network takes the output of the last hidden layer as input, and itself outputs values representative of the modal components of an impulse response.

Next, the computing device executes conversion module 103 to convert the learned modal components output by the neural network into filter coefficients that govern the behavior of IIR filter 105 (step 205). As mentioned, IIR filter 105 is typically represented as a cascade of multiple IIR filter sections, where each IIR filter section corresponds to important perceptual characteristics in the frequency spectrum such as peaks, valleys, or roll-offs which are modeled by the modal components output by the neural network. In some implementations, the modal components output by the neural network are inputs to equations derived offline for the digital filter coefficients of an analog prototype section having a desired filter shape (peak or shelf) and a desired filter order (i.e., N). For instance, N=2 for biquad filters. The equations for the digital filter coefficients are derived offline using a well-known bilinear transform. The quantities supplied by the neural network (gain, center frequency, and bandwidth-along with a sampling frequency of the digital signal), or intermediate values computed for convenience, are input in real-time by the computing device to the equations to produce the coefficients. Each one of the filter coefficients represents a value with which to configure a corresponding portion of IIR filter 105. The computing device configures IIR filter 105 with the coefficient values by, for example, setting parameters of the filter to the values (step 207).

Once configured, the computing device processes an anechoic audio signal 115 with IIR 105 filter to produce a spatialized audio signal 117 (step 209). The computing device may then output the spatialized audio signal in the form of audible sound that gives the impression to a listener that the sound originates from the desired direction of the (virtual) sound source.

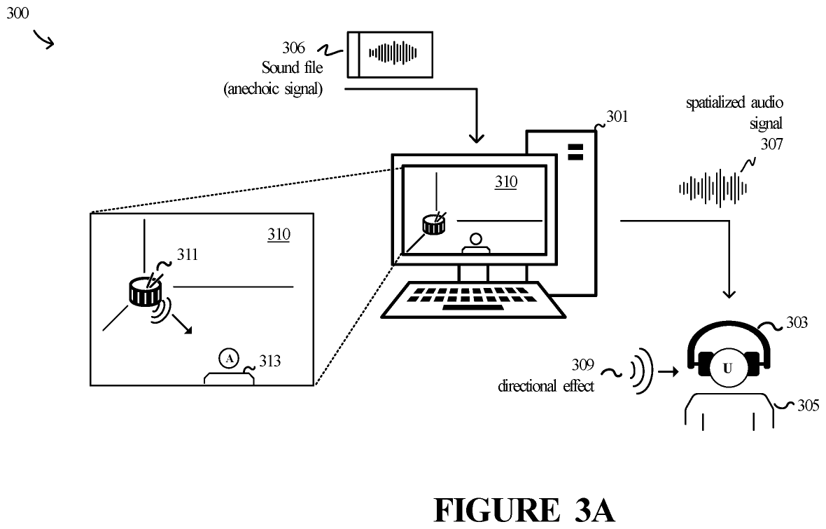

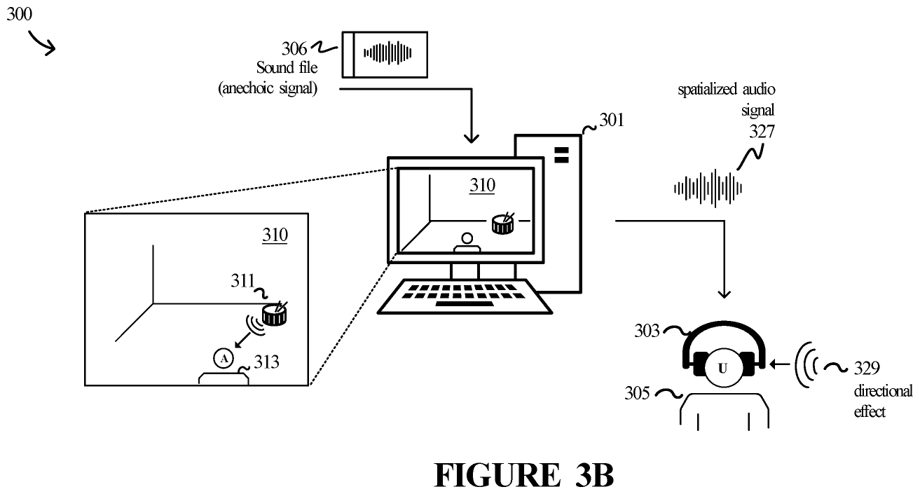

FIGS. 3A and 3B illustrate an operational example 300 of audio process 200. Operational example 300 involves computing device 301 and audio device 303. Computing device 301 is representative of a personal computer, server computer, tablet computer, gaming console, mobile phone, wearable device, or any other suitable computing device capable of employing system 100 and executing audio process 200. Audio device 303 is representative of any device(s) capable of receiving a spatialized audio signal and outputting audible sounds, examples of which include headsets, headphones, and speakers.

In some cases, computing device 301 and audio device 303 may be provided in the context of a single device such as virtual/augmented reality goggles or glasses. Alternatively, or in addition, the functionality provided by computing device 301 may be distributed across multiple computing devices such as in a client-server implementation. In still another alternative, or in addition, some or all of the functionality of computing device 301 may be present in audio device 303. That is, audio device 303 in some implementations may itself be capable of employing system 100 to execute audio process 200.

In the portion of operational example 300 illustrated in FIG. 3A, computing device 301 renders a virtual environment 310 on its screen. In this example, virtual environment 310 is representative of a gaming or virtual reality environment having a first-person perspective where user 305 navigates the environment via an avatar 313 on the screen. The avatar 313 is generally positioned at the center of the screen and is controllable by the user to navigate the environment. Virtual environment 310 includes object 311 positioned apart from avatar 313 and at a distance. Sounds “emitted by” object 311 may be produced from sound files used to render virtual environment 310. For example, sound file 306 may reside on computing device 301 such that it can be invoked and processed when triggered by object 311. The resulting “sounds” are communicated by computing device 301 via audio signals to audio device 303, which plays out real, analog sounds for the enjoyment of user 305.

It is desirable for the real sounds produced by audio device 303 to sound to user 305 as-if they are arriving from the same direction as that of object 311 relative to avatar 313 in virtual environment 310. Accordingly, computing device 301 employs audio process 200 to determine the sound source direction for sounds emitted by object 311 with respect to avatar 313. The virtual direction of the sound is fed by computing device 301 into a neural network that outputs modal components of an impulse signal. Computing device 301 converts the modal components into filter coefficients with which to configure an IIR filter.

Internal to computing device 301, a software component associated with object 311 generates an anechoic audio signal from sound file 306 that, without any modification, would be transmitted to and played out by audio device 303. The resulting sound would lack the desired directional effect as originating from the front and left of user 305. However, by employing audio process 200, computing device 301 is able to run the anechoic audio signal through the IIR filter, resulting in a spatialized audio signal 307. Computing device 301 then transmits the spatialized audio signal to audio device 303.

Audio device 303 receives and plays out the spatialized audio signal such as by driving speaker components that create sound waves having spatialized characteristics. Spatialized audio signal 307 may be in a digital or analog format when received from computing device 301. If in a digital format, audio device 303 converts the signal to analog and drives an output element based on the analog signal. The spatialized sound, when experienced by user 305, provides a directional effect of the sound arriving from the front and left of the user.

In FIG. 3B, operational example 300 continues with the assumption that user 305 has navigated avatar 313 to the left of object 311. Accordingly, the relative position of object 311 with respect to avatar 313 has changed, thereby changing the sound source direction. Computing device 301 inputs the new sound source direction into the neural network to obtain new modal components. The new modal components are then converted to new filter coefficients. The new coefficients cause the IIR filter to produce a new spatialized signal 327 that, when played out audio device 303, provides a new directional effect 329. The new directional effect gives user 305 the sense that the sound is arriving from the front and right at that moment, rather than from the front and left as in FIG. 3A.

In both FIG. 3A and FIG. 3B, spatialized audio is output immediately by computing device 301 to audio device 303 because operational example 300 is intended to illustrate a runtime scenario. However, it may be appreciated that system 100 and audio process 200 may be deployed in a pre-processing scenario where spatialized audio is created ahead of time, prior to its download and deployment to either a user computer, an audio device, or both.

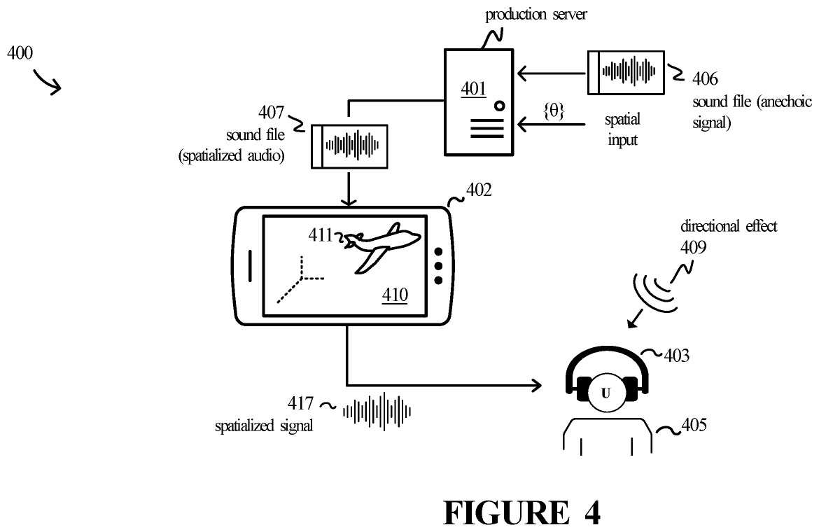

For example, in some implementations system 100 and audio process 200 may be employed in a media production environment to produce spatialized audio for movies, television shows, video games, animated video, video clips, and purely audio-based media that lacks video (e.g., audio books, music, and the like). FIG. 4 illustrates one such example.

In FIG. 4, operational example 400 involves production server 401, computing device 402, and audio device 403. Production server 401 is representative of any computer capable of employing system 100 and executing audio process 200. Computing device 402 is representative of any device capable of receiving spatialized audio data and outputting a spatialized audio signal represented in the data. Audio device 403 is representative of any device(s) capable of receiving a spatialized audio signal and outputting audible sounds, examples of which include headsets, headphones, and speakers. In some cases, computing device 402 and audio device 403 may be integrated into a single device such as a smart television with an integrated speaker(s), a mobile phone and its speaker(s), or the like.

In operation, production server 401 receives anechoic audio 406. The anechoic audio may be received as part of a multi-media file or group of files such as a movie, video clip, musical recording, or other such audio sources. In some cases, the audio may be received separately from the video. In other cases, the audio may be exclusive of any video such as with respect to a song, audio book, and so on.

Production server 401 also receives or otherwise obtains spatial input data. The spatial input data represents, for example, an assumed listener position at various points in time, thereby allowing production server 401 to produce spatialized audio data that is synchronized in time with the assumed listener positions. Alternatively, or in addition, the spatial input data may include assumed or annotated positions of sound source objects such as on-screen elements (e.g., a plane in the sky in a movie) or musical instruments (e.g., orchestral instruments positioned differently relative to each other and to an assumed center position of a listener).

Production server 401 may thus determine a relative position of sound sources to that of a virtual listener at various points in time. For each point in time, or each duration of an acceptable length, production server 401 determines the modal components of an impulse signal based on a sound source direction at that time (or for that duration of time). Production server 401 then converts the modal components to filter coefficients, with which it configures an IIR filter. The IIR filter filters the anechoic audio based on the coefficients, producing spatialized audio data in an audio file format.

In operational example 400, it is assumed for illustrative purposes that the virtual listener is positioned to the left of the sound source. For instance, the sound source may be a plane or other such object captured on video generally on the right side of the screen. The sound associated with the plane is therefore associated with a rightward sound source direction relative to a central position of the virtual listener.

Production server 401 supplies the rightward direction as spatial input to a neural network to obtain learned modal components representing design parameters of an IIR filter. Production server 401 converts the modal components to coefficients for the IIR filter. The IIR filter then processes the anechoic audio signal encoded in sound file 406 to produce a spatialized audio signal. The spatialized audio signal may then be encoded in sound file 407.

Production server 401 provides the spatialized audio data in sound file 407 to computing device 402 for output by audio device 403. It may be appreciated that production server 401 may provide the spatialized audio data indirectly to computing device 402 such as via one or more networks, through an online distribution channel, or in any other number of ways. Alternatively, or in addition, production server 401 may provide the spatialized audio data directly to computing device 402. Similarly, sound file 407 may be provided by production server 401 as a stand-alone file, as one of several files in a download, in the context of a larger media project such as a movie or video clip, or via any one of numerous delivery formats.

In any case, computing device 402 receives and stores sound file 407 for retrieval and playback at the appropriate time. For instance, computing device 402 may retrieve and play sound file 407 at a particular moment in a video game, in the context of a movie or a song, when playing a specific video clip, or whatever the moment may be that involves sound file 407.

In this example, it is assumed that sound file 407 represents the sound of an object 411 displayed in media environment 410 that outputs a familiar sound (e.g., that of a jet flying across the sky). At or around the moment in time that object 411 is displayed on the screen of computing device 402, sound file 407 is processed by computing device 402, resulting in spatialized audio signal 417. Computing device 410 transmits spatialized audio signal 417 to audio device 403 associated with user 405.

Audio device 403 receives spatialized audio signal 417 and processes it to generate an analog signal that drives the speaker components of the device to generate an audible sound heard by user 405. The audible sound, due to the spatialized characteristics of the audio signal, provides a directional effect 409 of the sound coming from the right side of the user. A similar effect could be provided with respect to orchestral music, for example, providing a user with the effect of some instruments playing to the right of the user, while others play from the left, all of which may be accomplished in a pre-processing environment such as that discussed immediately above with respect to FIG. 4.

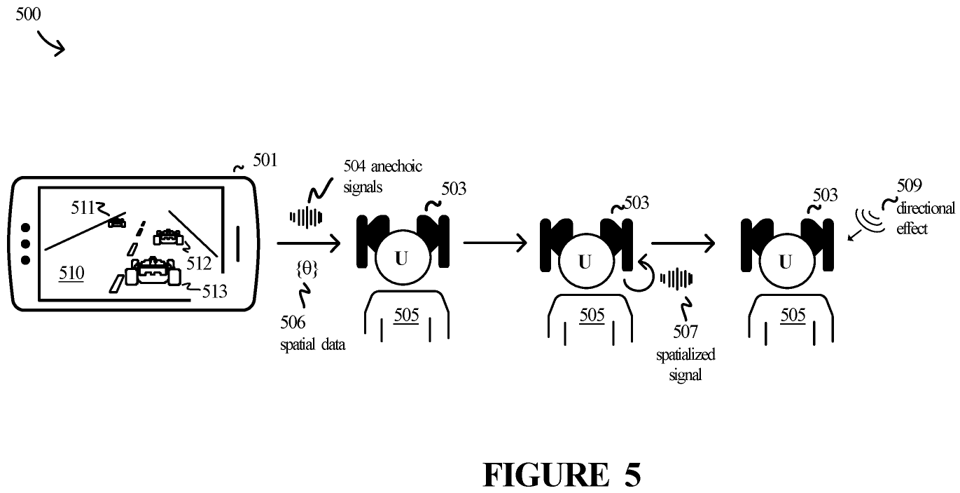

In FIGS. 3A and 3B, as well as in FIG. 4, a computer other than the audio device that outputs the final sound is responsible for turning anechoic signals into spatialized signals. In FIG. 5, an operational example 500 is provided whereby system 100 and audio process 200 are deployed locally with respect to an audio output device.

Operational example 500 involves computing device 501 and audio device 503. Computing device 501 is representative of a mobile phone, tablet computer, gaming console, personal computer, server computer, or any other suitable computing device capable of outputting an anechoic audio signal, as well as spatial data. Audio device 503 is representative of headphones (a/k/a earbuds), headsets, or speakers having the ability to process anechoic audio signals and spatial inputs to produce and output spatialized audio signals.

In operation, computing device 501 renders a game environment 510 on its screen, although any type of environment is possible such as virtual or augmented reality environments (or none at all, in the case of audio-only scenarios). Game environment 510 includes a first-person perspective where user 505 navigates the environment via a user-controlled object 513 on the screen. The user-controlled object 513 is generally positioned at the center of the screen and is controllable by the user to navigate the environment. In this example, game environment 510 is a racing game and user-controlled object 513 represents a race car.

Game environment 510 includes object 511 and object 512, both positioned apart from user-controlled object 513. Sounds “emitted by” object 511 or object 512 may be produced from sound files used to render game environment 510. For example, a sound file may reside on computing device 501 such that it can be invoked and processed when triggered by object 511. The resulting anechoic audio signals 504 are communicated by computing device 501 via audio signals to audio device 503, which plays out real analog sounds for consumption by user 505.

It is desirable for the real sounds produced by audio device 503 to sound to user 505 as-if they are arriving from the same direction as that of object 511 (or 512) relative to user-controlled object 513 in game environment 510. Accordingly, computing device 501 also provides spatial data 506 to audio device 503, allowing audio device 503 to convert the anechoic audio signals 504 to spatialized audio signals 507.

Audio device 503 employs system 100 and audio process 200 to determine the sound source direction for sounds emitted by object 511 (or object 512) with respect to user-controlled object 513. The virtual direction of the sound source, which is supplied by computing device 501 to audio device 503, is fed into a neural network executing on audio device 503 that outputs learned modal components of an impulse signal. Audio device 503 converts the modal components into filter coefficients with which to configure an IIR filter. The anechoic signals are then passed through the IIR filter to produce spatialized audio signals. Audio device 503 further processes the spatialized audio signals to generate analog signals that drive elements of the device that create sound waves. The resulting sound waves provide a directional effect 509 of one race car passing another in the context of game environment 510.

It may be appreciated that, as the position of user-controlled object 513 continues to change relative to object 511 and object 512, computing device 501 may continuously update audio device 503 with new spatial data. In such scenarios, audio device 503 inputs the new sound source directions into the neural network to obtain new modal components. The new modal components are then converted to new filter coefficients. The new coefficients drive the IIR filter to produce new spatialized signals that provide new directional effects.

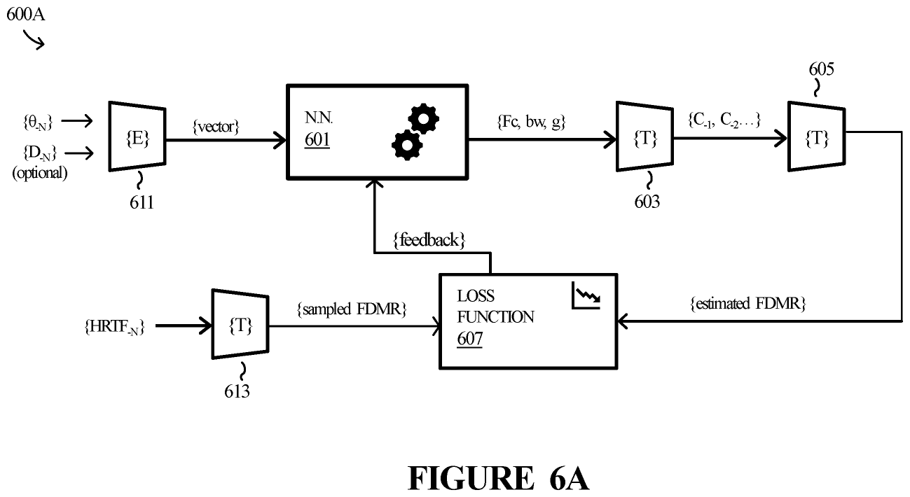

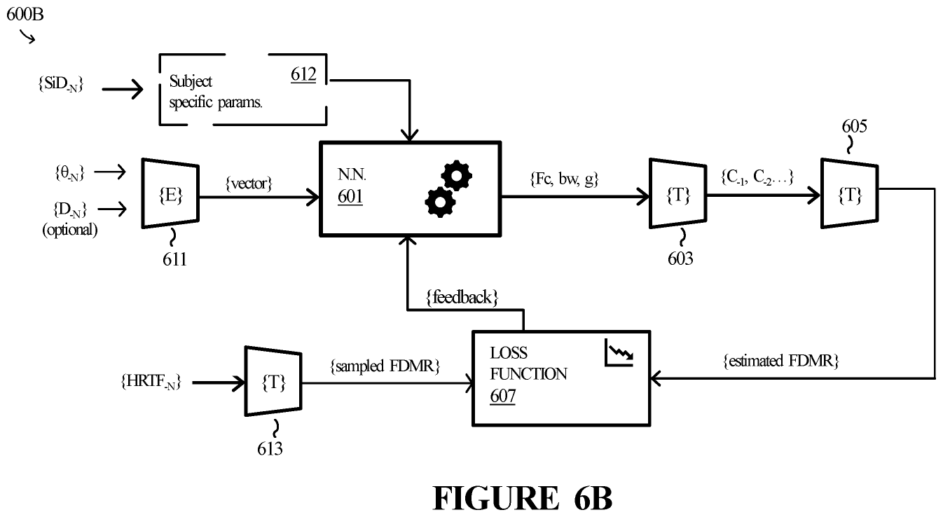

In the operational examples described above, the assumption is made that the neural network employed to generate learned modal components was trained accordingly. FIG. 6A illustrates a training environment 600A for training such models.

Training environment 600A, which may be implemented in computer hardware, software, and/or firmware, includes neural network 601, conversion module 603, response module 605, loss function 607, encoding module 611, and response module 613. Neural network 601 is operatively coupled with encoding module 611, conversion module 603, and loss function 607. Training environment 600A also includes response modules 605 and 613.

Neural network 601 and the other elements of training environment 600A may each be implemented in software or firmware executed by the circuitry of one or more processing devices of on a single computing device or distributed across multiple computing devices. Alternatively, or in addition, some or all of the functionality provided by any of the elements may be implemented entirely via application-specific integrated circuits or other such special purpose processing devices.

Generally speaking, training environment 600A is implemented separately from runtime environments such as system 100 in FIG. 1 in that models are trained in such environments and then deployed to runtime environments. However, it may be appreciated that some or all of training environment 600A may also be deployed in a runtime environment along with a trained or untrained model in order to provide further training of the model in the context of a local execution environment such as on a personal computer, mobile phone, or the like.

Encoding module 611 supplies feature vectors as input to neural network 601, which produces learned modal components as output. The feature vectors may be produced by encoding module 611 using random Fourier feature (RFF) mapping or other suitable mechanisms. For instance, in some implementations, encoding module 611 may be implemented via a machine learning algorithm (e.g., via neural network 601 or a separate network) to produce the feature vectors. Neural network 601 supplies the learned modal components as input to conversion module 603, which produces coefficient values as output. Response module 605 takes the coefficient values as input and produces an estimated frequency domain magnitude response as output, referred to hereafter as an estimated magnitude response.

Loss function 607 accepts the estimated magnitude response as input, while also accepting a sampled frequency domain magnitude response from response module 613, referred to hereafter as the sampled magnitude response. Response module 613 produces the sampled magnitude response using impulse response values in a training data set, while encoding function 611 encodes feature vectors with spatial data from the training set (and optionally other data).

Neural network 601 is representative of an artificial neural network or other such machine learning algorithm capable of processing spatial input and producing modal output. Encoding module 611 is representative of any functional block capable of encoding spatial data in feature vectors. Conversion module 603 is representative of any functional block capable of transforming modal components to IR filter coefficient values. Response module 605 is representative of a functional block capable of generating an estimated frequency domain magnitude response of a filter based on the filter's coefficients. Response module 613 is representative of a functional block capable of generating a magnitude response in the frequency domain of a sample impulse response. Loss function 607 is representative of any functional block capable of comparing the outputs of response module 605 and response module 613 to generate feedback with which to adjust parameters of neural network 601.

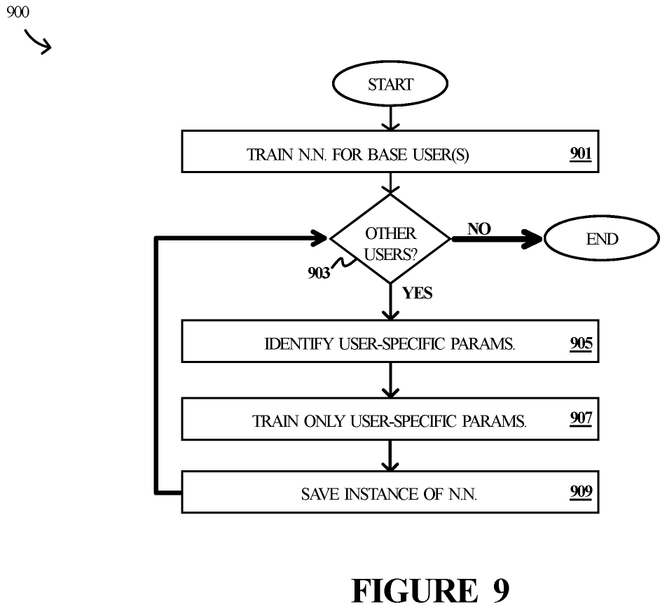

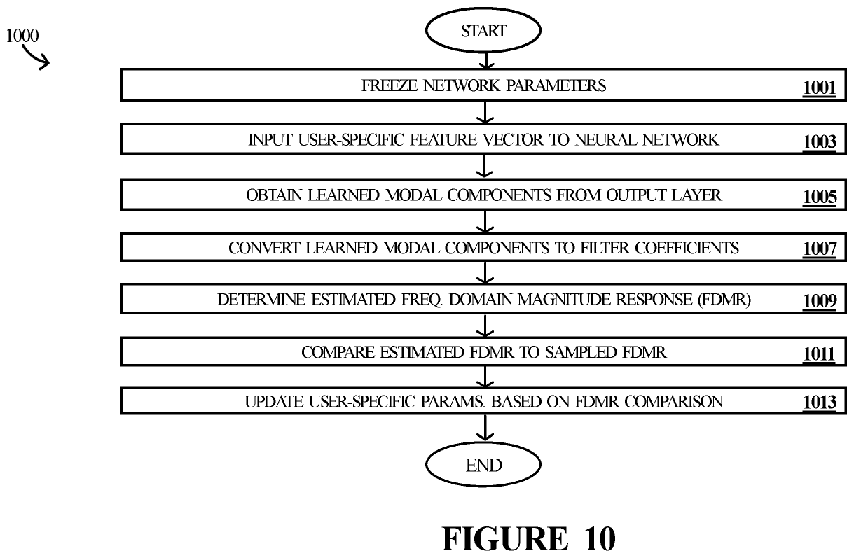

FIG. 6B illustrates training environment 600B, which is a variation on training environment 600A. Training environment 600B is the same as training environment 600A and includes all the same elements, with the addition of subject-specific parameters 612. Subject-specific parameters 612 represent features associated with specific subjects that allow neural network 601 to be trained on multiple subjects. Subject-specific parameters 612 are supplied as additional input to neural network 601, in addition to the feature vectors that are fed to the input layer of the network. Subject-specific parameters 612 are used to govern how the biases and parameters of neural network 610 are configured and/or updated such that the network learns to interpolate modal components on a per-subject basis, discussed in more detail below with respect to FIG. 9 and FIG. 10 related to multi-subject training.

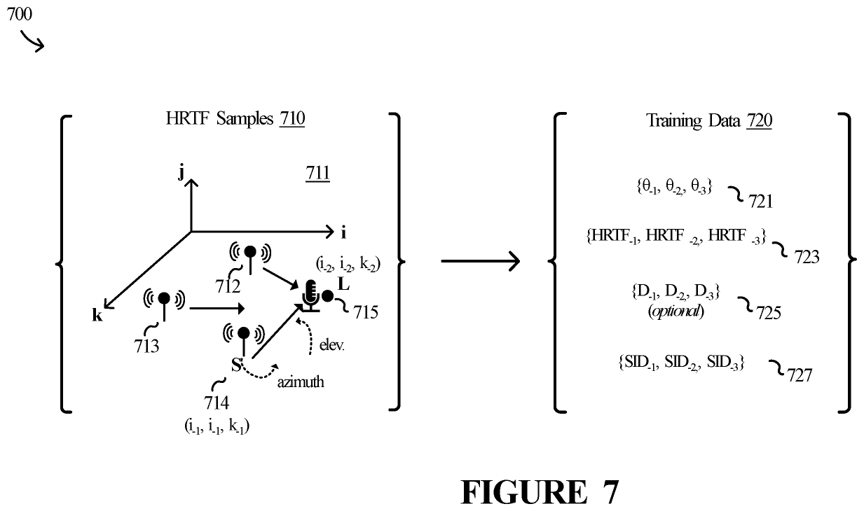

FIG. 7 illustrates a data set 700 utilized by the elements of training environment 600A and/or training environment 600B to train a model. Data set 700 includes HRTF samples 710 and training data 720. HRTF samples 710 include samples taken in the context of a sampling environment 711. Each individual sample is created by locating sound sources at different positions (or by moving a single sound source to the different positions) and, at discrete moments in time, generating an audio impulse signal (sound wave) that is captured by a microphone or other such sensor(s) at a listener position 715. Here, the different sound source positions are represented by position 712, position 713, and position 714.

Using position 714 as an example, each sample is defined in terms of its coordinates in three dimensions (i, j, and k) of sampling environment 711. A sound source direction of each impulse is calculated based on the specific location of the sound source that created each impulse relative to the i-j-k coordinates of listener position 715. A distance between the sound source position and the listener position may also be calculated. The sound source direction may be represented by azimuth and elevation angles formed by the two positions (sound source position and listener position) recorded for each sample.

Training data 720 is created from the samples taken in sampling environment 711 and includes sound source direction information 721, HRTF information 723, distance information 725 (which is optional), and subject identities, or SID data 727. In other words, training data 720 includes, for each individual sample: a sound source direction; an HRTF; distance (optional); and a subject identity. Training data 720 is employed by the elements of training environment 600A when executed by training process 800 to train neural network 601.

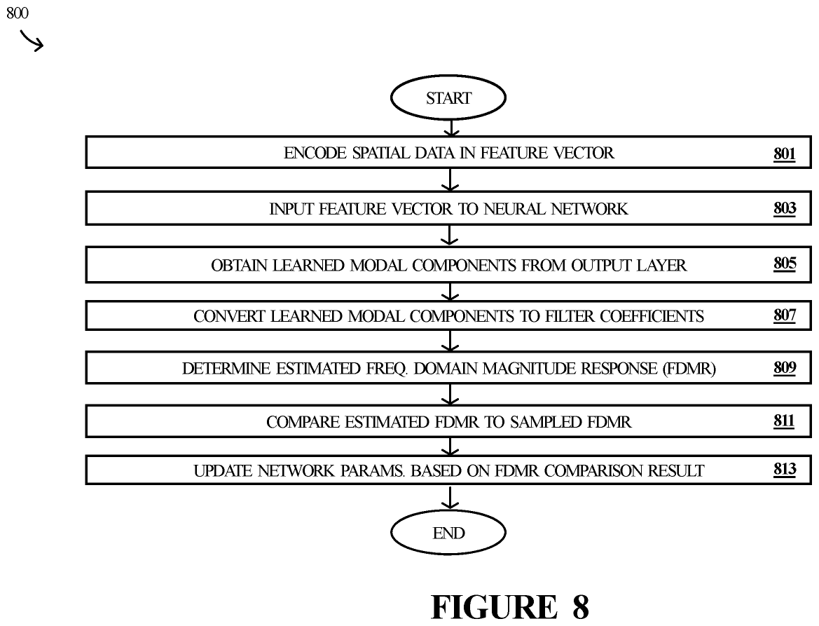

Training process 800, illustrated in FIG. 8, may be implemented in program instructions in the context of the software and/or firmware elements of training environment 600A. The program instructions, when executed by one or more processing devices of one or more suitable computing devices, direct the one or more computing devices to operate as follows, referring parenthetically to the steps of FIG. 8. It may be appreciated the training process 800, while generally representative of how neural network 601 is trained, is highly simplified and provides merely a snapshot into the training process with respect to a single training cycle and a single feature vector.

In operation, the computing device executing encoding function 611 extracts spatial data from an impulse response sample and encodes the spatial data in a feature vector (step 801). The feature vector may be generated based on random Fourier feature (RFF) mapping, for example, or other suitable vectorization techniques. Optionally, other information may be encoded in the vector as well such as distance. The computing device proceeds to input the feature vector to neural network 601 (step 803). Neural network 601 includes an input layer, one or more hidden layers, and an output layer.

Next, the computing device executes neural network 601 to obtain learned modal components based on the spatial input (step 805). The input layer includes n-number of input nodes that correspond to n-dimensions of the feature vector. The input nodes process corresponding portions of the feature vector and pass their outputs to the hidden layers of the neural network. Each hidden layer takes the output of a previous layer as input and provides output to a subsequent layer of the neural network. The output layer of the neural network takes the output of the last hidden layer as input, and itself outputs values representative of the modal components of an impulse response.

The computing device then executes conversion module 603 to convert the learned modal components output by the neural network into filter coefficients (step 807). Each one of the filter coefficients represents a value with which to configure a corresponding portion of an IIR filter. The coefficients are supplied to response module 605, which determines an estimated magnitude response of the IIR filter based on the coefficients (step 809). This may be accomplished by, for example, inputting the coefficient values and a complex exponential at each frequency of interest into the transfer function for the filter, and taking the magnitude of the resulting complex number as the estimated magnitude response. The computing devices supplies the estimated magnitude response as input to loss function 607.

In some cases, as an alternative to directly converting the filter coefficients to the estimated magnitude response, an IIR filter may be configured based on the coefficients and supplied with the impulse response (HRTF) associated with the current training cycle and input. Taking the impulse response as input, the IIR filter would produce an output signal that could be analyzed to determine the estimated magnitude response.

Regardless of the manner in which the estimated magnitude response is determined, loss function 607 compares the estimated magnitude response to a sampled magnitude response generated by response module 613 for the HRTF sample associated with the feature vector (step 811). The result of the comparison provides feedback to the training of neural network 601. That is, the computing device updates the parameters and/or biases of neural network 601 based on the result of the comparison (step 813). Updating the parameters and/or biases includes changing some or all of the parameter and bias values, as well as refraining from further updates if the result of the comparison indicates the training is complete.

FIG. 9 illustrates a multi-subject training process 900 in an implementation whereby a neural network may be trained to learn modal components on a per-subject basis. Multi-subject training process 900 may be implemented in program instructions in the context of the software and/or firmware elements of training environment 600B. The program instructions, when executed by one or more processing devices of one or more suitable computing devices, direct the one or more computing devices to operate as follows, referring parenthetically to the steps of FIG. 9. It may be appreciated that multi-subject training process 900, while generally representative of how neural network 601 is trained, is highly simplified and provides merely a snapshot into the multi-subject training process.

In operation, the computing device trains neural network 601 with respect to a base user or a base group of users (step 901). Such training may be accomplished by employing training process 800 described with respect to FIG. 8. The base training process may be subject-agnostic in that no subject-specific parameters are used when updating the parameters and biases of the network. However, the feature vectors would be encoded with a subject ID associated with each base user, in addition to the spatial data encoded in the vectors.

Next, the computing device determines whether samples remain for other users after the base group (step 903). That is, the computing device determines whether to continue training the model for other users once the model has been trained on the training data associated with the base user(s). If not, then the training is complete, and a base instance of the neural network may be deployed with respect to the first user and/or other users of a base group of users, where applicable. However, if other non-baseusers remain, the computing device proceeds to determine subject-specific parameters for the next user (step 905).

In some cases, the subject-specific parameters are represented by a one-hot vector uniquely associated with a specific subject. The subject-specific parameters allow the computing device to train only those parameters or biases of the network specific to the next user and/or to otherwise configure the training on a per-subject basis (907). The updated version of the neural network is then saved-off in association with the current subject, to be employed later in association with that subject (step 909). The process returns to Step 903 until no other subjects remain. The training carried out with respect to Step 907 is a subject-specific process described below with respect to FIG. 10.

In some implementations, the subject specific parameters include an N-dimensional learned embedding vector for each subject, in which case the network parameter updates involve applying a feature-wise linear modulation (FiLM) layer applied to each of the hidden layers in the neural network. In the FiLM case, when a new subject is added, only an additional N-dimensional learned embedding vector for that subject needs to be added to the network, while the remaining parameters remain frozen to their base values. Alternatively, the subject specific parameters may be the bias vectors for a subset of the network's hidden layers, in which case updating the neural network parameters for given a specific subject involves updating only a subset of bias terms corresponding to that specific subject. Such an approach is typically referred to as BitFit.

In another alternative, the weight matrices for a subset of the network's hidden layers are the subject specific parameters. However, instead of having the full weight matrices as the subject specific parameters, a low-rank adaptation (LoRA) approach is used to fine-tune the network. Here, each weight matrix would be represented as the product of two low-rank vectors, which would beneficially reduce the number of subject specific parameters needing to be stored. Then, to update neural network's parameters for a specific subject, only the weight matrices computed as the low-rank product of the vectors corresponding to that subject would be updated.

It may be appreciated that, for each subsequent subject after the base subject(s), a relatively small number of HRTF samples need be used to update the network for the next subject. That is, certain parameters of the neural network are frozen for subsequent subjects, while only subject-specific parameters are updated. FIG. 10 briefly illustrates subject-specific training process 1000, which applies when training neural network 601 on subsequent subjects, after having trained the network on a base subject.

Subject-specific training process 1000 may be implemented in program instructions in the context of the software and/or firmware elements of training environment 600B. The program instructions, when executed by one or more processing devices of one or more suitable computing devices, direct the one or more computing devices to operate as follows, referring parenthetically to the steps of FIG. 10. It may be appreciated that subject-specific training process 1000, while generally representative of how neural network 601 is trained, is highly simplified and provides merely a snapshot into the subject-specific training process.

In operation, the computing device freezes the parameters of neural network 601 in their present state after having been trained on training data associated with a base subject or group of base subjects (step 1001). Next, the computing device inputs a subject-specific feature vector into the input layer of neural network 601 (step 1003). The subject-specific feature vector has encoded therein at least a spatial input and a subject ID associated with a given listener.

The computing device executes neural network 601 against the subject-specific feature vector to obtain learned modal components (step 1005). The computing device then executes conversion module 603 to convert the learned modal components output by the neural network into filter coefficients (step 1007). Each one of the filter coefficients represents a value with which to configure a corresponding portion of an IIR filter. The coefficients are supplied to response module 605, which determines an estimated magnitude response of the IIR filter based on the coefficients (step 1009). The computing devices supplies the estimated magnitude response as input to loss function 607.

Loss function 607 compares the estimated magnitude response to a sampled magnitude response generated by response module 613 for the HRTF sample associated with the feature vector (step 1011). The result of the comparison provides feedback to the training of neural network 601. That is, the computing device updates only the user-specific parameters and/or biases of neural network 601 based on the result of the comparison (step 1013).

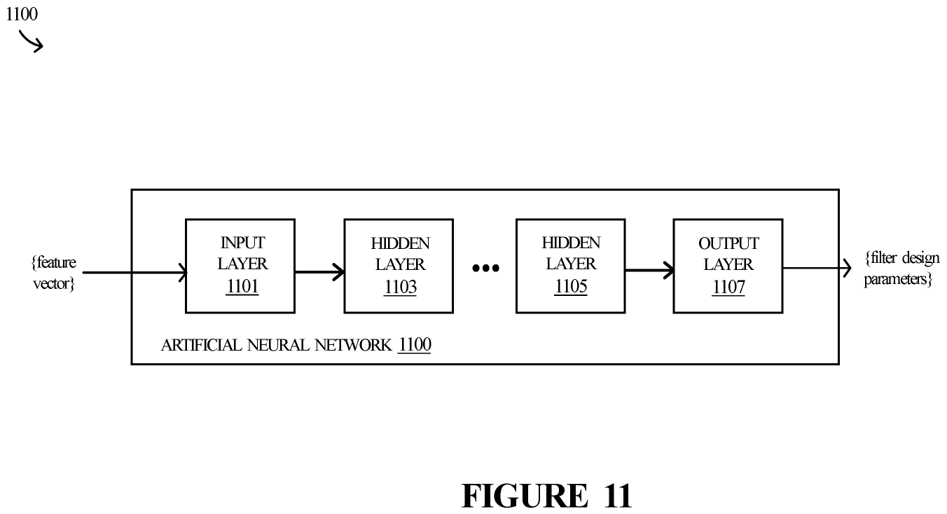

FIG. 11 illustrates an artificial neural network 1100, which is representative of the neural networks discussed herein, including neural network 101 and neural network 601. Artificial neural network 1100 includes an input layer 1101, multiple hidden layers represented by hidden layer 1103 and hidden layer 1105, and an output layer 1107. Input layer 1101 takes feature vectors having sound source directions encoded therein as input. Output layer 1107 produces filter design parameters as output in the form of learned modal components.

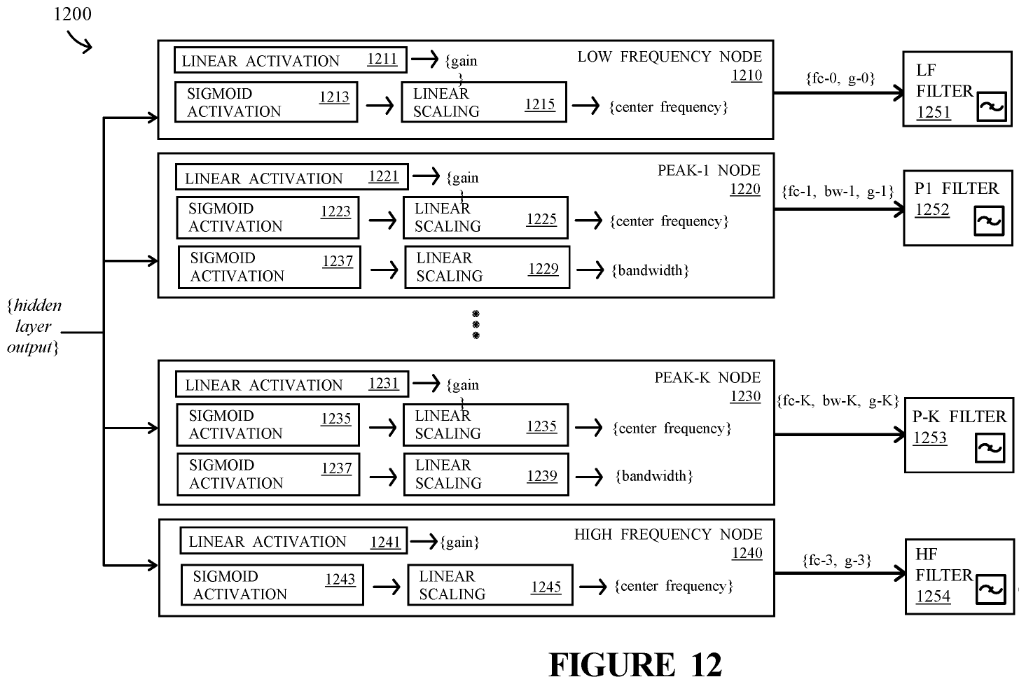

FIG. 12 illustrates an exemplary output layer in more detail. Output layer 1200 includes four components (or nodes) that each produce different output. The nodes include a low frequency (LF) node 1210, a first peak node (peak node 1220), a Kth-peak node (peak node 1230), and a high frequency (HF) node 1240. Each node in the final hidden layer connects to each of the nodes in output layer 1200. The hidden layer outputs feed into various functions internal to each of the output nodes including linear activation functions, sigmoid activation functions, and linear scaling functions.

LF node 1210 includes a linear activation function 1211, a sigmoid activation function 1213, and a linear scaling function 1215. Linear activation function 1211 generates a gain value based on hidden layer output. Sigmoid activation function 1213, in conjunction with linear scaling function 1215, produces a center frequency value. The gain and center frequency values produced by LF node 1210 are supplied as design parameters for an LF filter component 1251 of an IIR filter. The design parameter values may be converted to filter coefficient values with which to configure LF filter component 1251.

Peak node 1220 includes a linear activation function 1221, two sigmoid activation functions (1223 and 1227) and two corresponding linear scaling functions 1225 and 1229. Linear activation function 1221 generates a gain value based on hidden layer output. Sigmoid activation function 1223, in conjunction with linear scaling function 1225, produces a center frequency value. Sigmoid activation function 1227, in conjunction with linear scaling function 1229, produces a bandwidth value. The gain, center frequency, and bandwidth values produced by peak node 1220 are supplied as design parameters for a peak filter component 1252 of the IIR filter. The design parameter values may be converted to filter coefficient values with which to configure peak filter component 1252.

Peak node 1230 also includes a linear activation function 1231, two sigmoid activation functions (1233 and 1237) and two corresponding linear scaling functions 1235 and 1239. Linear activation function 1231 generates a gain value based on hidden layer output. Sigmoid activation function 1233, in conjunction with linear scaling function 1235, produces a center frequency value. Sigmoid activation function 1237, in conjunction with linear scaling function 1239, produces a bandwidth value. The gain, center frequency, and bandwidth values produced by peak node 1230 are supplied as design parameters for a peak filter component 1253 of the IIR filter. The design parameter values may be converted to filter coefficient values with which to configure peak filter component 1253.

HF node 1240 includes a linear activation function 1241, a sigmoid activation function 1243, and a linear scaling function 1245. Linear activation function 1241 generates a gain value based on hidden layer output. Sigmoid activation function 1243, in conjunction with linear scaling function 1245, produces a center frequency value. The gain and center frequency values produced by HF node 1240 are supplied as design parameters for an HF filter component 1254 of the IIR filter. The design parameter values may be converted to filter coefficient values with which to configure HF filter component 1254.

Various embodiments of the present technology discussed above provide for a wide range of technical effects, advantages, and/or improvements to computing systems and components. For example, various embodiments may include one or more of the following technical effects, advantages, and/or improvements: 1) the non-routine and unconventional dynamic implementation of spatialized interpolation of modal components; 2) non-routine and unconventional operations for the spatialized training of neural networks; 3) the dynamic transformation of anechoic audio signals into spatialized audio signals; 4) the non-routine and unconventional use of subject-specific parameters to train neural networks to perform spatialized interpolation of modal components on a subject-specific basis; and 5) the non-routine and unconventional use of subject-specific parameters during inference to produce learned modal components on a subject-specific basis. In addition, the lower computational complexity of IIRs relative to FIRs make the disclosed interpolation techniques especially applicable in resource constrained environments or any setting in which power conservation is valued.

It may be further appreciated that the disclosed embodiments allow a neural network to be trained from a limited data set because the number of output values are lower, relative to previous techniques. That is, existing approaches output the entire magnitude frequency response, i.e., a gain value at each frequency, of a given HRTF. A magnitude response is typically approximated at thousands of different frequencies, and therefore the size of the output layer in the pre-existing approach is the number of frequencies, i.e., several thousand. Given that the number of available HRTFs for model training is quite limited, accurately learning a neural network to output so many values is difficult and impractical. In addition, deploying a neural network with so many output values in resource constrained environments is difficult and impractical.

In contrast, the modal approach disclosed herein produces a much smaller number of outputs: typically 30-100 outputs depending on the number of peaking filters (K). As it is typically easier to accurately learn a neural network model from limited data if the number of values to output are smaller, the modal approach disclosed herein provides a performance advantage in speed and resource consumption relative to the pre-existing approaches. Furthermore, the modal components disclosed herein approximate the most important perceptual features of the impulse response, and the modeling capacity of the neural network is spent on these features, whereas pre-existing approaches waste modeling capacity, attempting to estimate many low-level details of the magnitude frequency response that are often perceptually irrelevant.

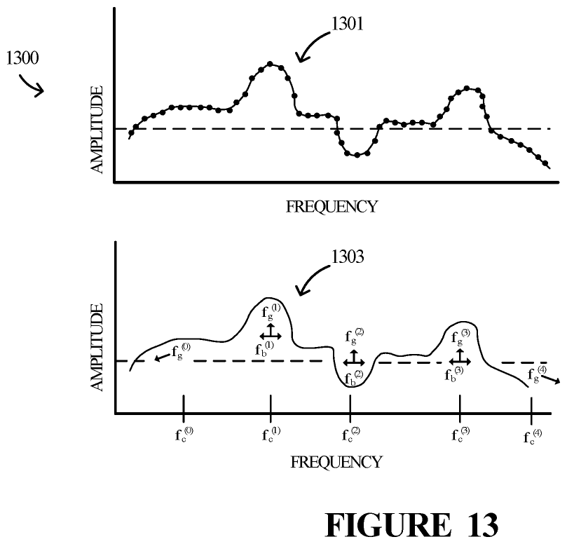

FIG. 13 briefly illustrates the two approaches. Chart 1301 illustrates a highly simplified representation of the number of data points estimated by a neural network for a given impulse response. Each data point in chart 1301 represents the amplitude of the signal at a given frequency. In contrast, chart 1303 represents the modal approach, where only thirteen values need be estimated (K=3), namely: three values for each peaking filter (center frequency (fc), bandwidth (fb), and gain (g) for k=1, 2, 3); a center frequency and gain for the low shelf filter (k=0), and a center frequency and gain for the high shelf filter (k=4). Furthermore, the estimated modal values correspond to the most important perceptual characteristics in the frequency spectrum, peaks/valleys (modeled by the peaking filters), and spectral roll-offs (modeled by the shelf filters).

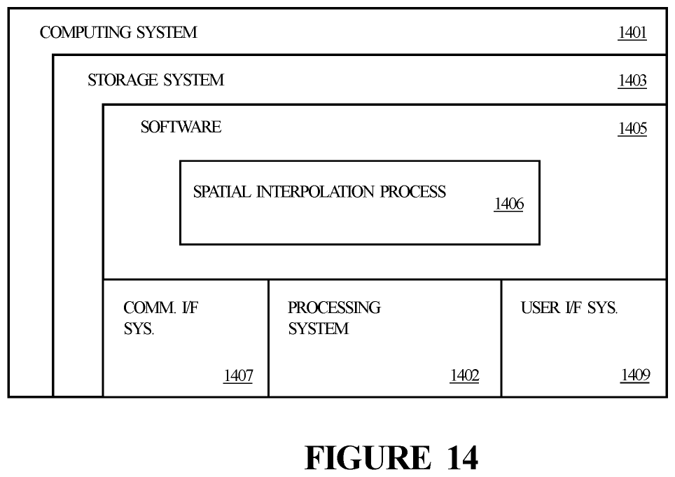

FIG. 14 illustrates computing device 1401 that is representative of any system or collection of systems in which the various processes, programs, services, and scenarios disclosed herein may be implemented. Examples of computing device 1401 include, but are not limited to, desktop and laptop computers, tablet computers, mobile computers, audio devices, and wearable devices. Examples may also include server computers, web servers, cloud computing platforms, and data center equipment, as well as any other type of physical or virtual server machine, container, and any variation or combination thereof.

Computing device 1401 may be implemented as a single apparatus, system, or device or may be implemented in a distributed manner as multiple apparatuses, systems, or devices. Computing device 1401 includes, but is not limited to, processing system 1402, storage system 1403, software 1405, communication interface system 1407, and user interface system 1409. Processing system 1402 is operatively coupled with storage system 1403, communication interface system 1407, and user interface system 1409.

Processing system 1402 loads and executes software 1405 from storage system 1403. Software 1405 includes and implements spatial interpolation process 1406, which is representative of audio processes 200, training process 800, multi-subject training process 900, and subject-specific training process 1000. When executed by processing system 1402, software 1405 directs processing system 1402 to operate as described herein for at least the various processes, operational scenarios, and sequences discussed in the foregoing implementations. Computing device 1401 may optionally include additional devices, features, or functionality not discussed for purposes of brevity.

Referring still to FIG. 14, processing system 1402 may comprise a micro-processor and other circuitry that retrieves and executes software 1405 from storage system 1403. Processing system 1402 may be implemented within a single processing device but may also be distributed across multiple processing devices or sub-systems that cooperate in executing program instructions. Examples of processing system 1402 include general purpose central processing units, graphical processing units, digital signal processors, application specific processors, and logic devices, as well as any other type of processing device, combinations, or variations thereof.

Storage system 1403 may comprise any computer readable storage media readable by processing system 1402 and capable of storing software 1405. Storage system 1403 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1403 may also include computer readable communication media over which at least some of software 1405 may be communicated internally or externally. Storage system 1403 may be implemented as a single storage device but may also be implemented across multiple storage devices or sub-systems co-located or distributed relative to each other. Storage system 1403 may comprise additional elements, such as a controller, capable of communicating with processing system 1402 or possibly other systems.

Software 1405 (including spatial interpolation process 1406) may be implemented in program instructions and among other functions may, when executed by processing system 1402, direct processing system 1402 to operate as described with respect to the various operational scenarios, sequences, and processes illustrated herein. For example, software 1405 may include program instructions for implementing the inference and training processes described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1405 may include additional processes, programs, or components, such as operating system software, virtualization software, or other application software. Software 1405 may also comprise firmware or some other form of machine-readable processing instructions executable by processing system 1402.

In general, software 1405 may, when loaded into processing system 1402 and executed, transform a suitable apparatus, system, or device (of which computing device 1401 is representative) overall from a general-purpose computing system into a special-purpose computing system customized to perform inference and/or training in an optimized manner. Indeed, encoding software 1405 on storage system 1403 may transform the physical structure of storage system 1403. The specific transformation of the physical structure may depend on various factors in different implementations of this description. Examples of such factors may include, but are not limited to, the technology used to implement the storage media of storage system 1403 and whether the computer-storage media are characterized as primary or secondary storage, as well as other factors.

For example, if the computer readable storage media are implemented as semiconductor-based memory, software 1405 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1407 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 1401 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. An audio processing method, wherein the method uses a processor coupled with stored instructions implementing the method, wherein the instructions, when executed by the processor, carry out steps of the method, comprising:
executing a neural network to produce a modal output based at least on spatial input, wherein the spatial input comprises a sound source direction, and wherein the modal output comprises learned modal components of an impulse response generated by the neural network based on the sound source direction;
determining coefficients for an infinite impulse response (IIR) filter based on the learned modal components of the impulse response generated by the neural network; and
processing an anechoic audio signal with the IIR filter configured with the coefficients to produce a spatialized audio signal.

2. The audio processing method of claim 1 wherein the learned modal components of the impulse response comprise center frequency, bandwidth, and gain.

3. The audio processing method of claim 2 wherein the sound source direction comprises a direction of a sound source relative to a listener position, and wherein the impulse response comprises a head-related transfer function (HRTF).

4. The audio processing method of claim 3 wherein the anechoic audio signal comprises a sound associated with the sound source, and wherein the steps of the method further comprise configuring the IIR filter with the coefficients and outputting the spatialized audio signal to produce a directional effect of the sound at the listener position.

5. The audio processing method of claim 4 wherein steps of the method further comprise training the neural network with training data to produce modal outputs based on spatial inputs.

6. The audio processing method of claim 5 wherein the training data comprise HRTF samples associated with the listener position, and wherein the direction of the sound source in each of the HRTF samples differs relative to each other sample of the HRTF samples.

7. The audio processing method of claim 6 wherein training the neural network with the training data comprises, for each one of the HRTF samples:
supplying the direction of the sound source as input to the neural network;
obtaining output from the neural network comprising the learned modal components of the HRTF associated with the direction of the sound source;
determining the coefficients for the IIR filter based on the learned modal components;
determining an estimated frequency domain magnitude response of the IIR filter based on the coefficients; and
performing a comparison of the estimated frequency domain magnitude response of the IIR filter to a known frequency domain magnitude response of the HRTF; and
updating weights in the artificial neural network based on the comparison.

8. The audio processing method of claim 7 wherein the training data further comprise listener identities associated with the HRTF samples, and wherein the input to the neural network further includes a one of the listener identities associated with the one of the HRTF samples.

9. A computing device comprising:
processing circuitry configured to at least:
execute a neural network to process a spatial input, the neural network being trained to produce a modal output, wherein the spatial input comprises a sound source direction, and wherein the modal output comprises learned modal components of an impulse response associated with the sound source direction;
determine coefficients for an infinite impulse response (IIR) filter based on the learned modal components of the impulse response obtained from the neural network; and
process an audio signal with the IIR filter configured with the coefficients to increase a spatialization of the audio signal; and
audio circuitry configured to output the audio signal.

10. The computing device of claim 9 wherein the sound source direction comprises a direction of a sound source relative to a listener position, and wherein the impulse response comprises a head-related transfer function (HRTF) modeled by the neural network for the listener position with respect to the direction of the sound source.

11. The computing device of claim 10 wherein the audio signal comprises a sound associated with the sound source, and wherein the processing circuitry is further configured to program the IR filter with the coefficients.

12. The computing device of claim 11 wherein the neural network is trained with training data to produce modal outputs based on spatial inputs.

13. The computing device of claim 12 wherein the training data comprise HRTF samples associated with the listener position.

14. The computing device of claim 13 wherein the direction of the sound source in each sample of the HRTF samples differs relative to each other sample of the HRTF samples.

15. The computing device of claim 14 wherein the training data further comprise listener identities associated with the HRTF samples, and wherein the spatial input further comprises an identity of a listener.

16. The computing device of claim 9 wherein the IIR filter comprises a cascaded IIR filter having multiple IIR filter sections, and wherein the multiple IIR filter sections include a low-frequency (LF) section, a peak frequency (PF) section, and a high-frequency (HF) section.

17. The computing device of claim 16 wherein the learned modal components of the impulse response comprise: a) center frequency and gain for the LF section; b) center frequency, bandwidth, and gain for the PF section; and c) center frequency and gain for the HF section.

18. One or more computer readable storage media having program instructions stored thereon that, when executed by one or more processors of a computing device, direct the computing device to at least:
supply spatial input to a neural network that produces a modal output based on the spatial input, wherein the spatial input comprises a sound source direction, and wherein the modal output comprises learned modal components of an impulse response generated by the neural network based on the sound source direction;
determine coefficients for an infinite impulse response (IIR) filter based on the learned modal components of the impulse response generated by the neural network; and
configure the IIR filter based on the coefficients.

19. The one or more computer readable storage media of claim 18 wherein the program instructions further direct the computing device to process an anechoic audio signal with the IIR filter configured with the coefficients to produce a spatialized audio signal.

20. The one or more computer readable storage media of claim 19 wherein the sound source direction comprises a direction of a sound source relative to a listener position, and wherein the impulse response comprises a head-related transfer function (HRTF) modeled by the neural network for the listener position with respect to the direction of the sound source.

21. A method of training an artificial neural network, the method comprising:
extracting spatial features from impulse response samples, wherein each of the impulse response samples comprises a spatial feature and an associated impulse response;
for each one of the impulse response samples:
supplying the feature vector as input to the artificial neural network;
obtaining output from the artificial neural network comprising learned modal components of the impulse response;
determining coefficients for an impulse response (IR) filter based on the learned modal components of the impulse response;
determining an estimated frequency domain magnitude response of the IR filter based on the coefficients; and
performing a comparison of the estimated frequency domain magnitude response of the IR filter to a known frequency domain magnitude response of the impulse response; and
updating weights in the artificial neural network based on the comparison.

22. The method of claim 21 wherein the IR filter comprises an infinite impulse response (IIR) filter, and wherein the learned modal components comprise center frequency, bandwidth, and gain.

23. The method of claim 22 wherein the impulse response comprises one of a head-related transfer function (HRTF) or a room impulse response (RIR).
